(19) United States
(12) Patent Application Publication
(10) Pub. No.: US 2005/0146331 A1
(43) Pub. Date: Jul. 7, 2005

(54) Transmit-receive coil system for nuclear quadrupole resonance signal detection in substances and components thereof

(76) Inventors: John Harold Flexman, Kardinya (AU); Warrick Paul Chisholm, Ferndale (AU); Taras Nikolaevitch Rudakov, Willetton (AU); Vassili Timofeevitch Mikhaltsevitch, St. James (AU); Peter Alaric Hayes, Wembley Downs (AU)

Correspondence Address: MICHAEL D. BEDNAREK;SHAW PITTMAN LLP, 1650 TYSONS BOULEVARD, MCLEAN, VA, 22102, US

(21) Appl. No.: 10/985,001

(22) Filed: Nov. 10, 2004

(30) Foreign Application Priority Data
May 12, 2003 (WO) PCT/AU03/00563
May 10, 2002 (AU) PS 2247

(51) Int. Cl. G01V 3/00

(52) U.S. Cl. 324/318

(57) ABSTRACT

An antenna and shield apparatus for detecting phenomenal signals using nuclear and electronic resonance detection technology, comprising: a transmit and receive antenna, an electric field shield 60 and an outer shield 52. The antenna is a multiple parallel loop transmit-receive antenna forming a main coil assembly 11 having a plurality of loop segments 20 optionally interconnected by connectors in the form of conducting bars 10, relays 16, or nothing. The electric field shield 60 comprises an inner sleeve of conducting material 60, 68 disposed on the inside of the coil assembly 11 for shielding the electric field emanating from the coil assembly 11 from the target volume circumscribed by the assembly. The outer shield 52 comprises a central screen portion 55, waveguides 57 at either end thereof and a sloping channel portion for interconnecting the two. The coil assembly 11 and the electric field shield 60 are housed within the outer shield 52.

### FIELD OF THE INVENTION

This invention relates to the detection of particular substances using nuclear and electronic resonance detection technology. It has particular application, with respect to nuclear quadrupole resonance (NQR), but also application with respect to nuclear magnetic resonance (NMR), magnetic resonance imaging (MRI) and electron spin resonance (ESR) technologies. More specifically, the invention relates to a transmit-receive coil system, which has multiple coil segments that can be used for the detection of NQR signals in an NQR application (or other phenomenal signals pertaining to the particular technology used) in substances disposed within a spatially small electric field.

The invention has particular, but not exclusive, utility in the detection of explosives and narcotics located within mail, airport luggage and other packages.

Throughout the specification, unless the context requires otherwise, the word “comprise” or variations such as “comprises” or “comprising”, will be understood to imply the inclusion of a stated integer or group of integers but not the exclusion of any other integer or group of integers.

### BACKGROUND ART

The following discussion of the background art is intended to facilitate an understanding of the present invention only. It should be appreciated that the discussion is not an acknowledgement or admission that any of the material referred to is or was part of the common general knowledge as at the priority date of the application.

Unobtrusive detection of explosives and narcotics can be achieved by various methods, of which X-ray, chemical trace particle detection, thermal neutron activation & nuclear quadrupole resonance are currently the most promising techniques. NQR is one of many modern research methods in physics used for the analytical detection of chemical substances in solid form. NQR is a radio frequency (RF) spectroscopy, and it is defined as a phenomenon of resonant RF absorption or emission of electromagnetic energy. It is due to the dependence of a portion of the energy of electron-nuclear interactions on the mutual orientations of asymmetrically distributed charges of the atomic nucleus and the atomic shell electrons as well as those charges that are outside the atomic radius. Thus, all changes in the quadrupole coupling constants and NQR frequencies are due to their electric origin.

More particularly, the nuclear electric quadrupole moment eQ interacts with the electric field gradient eq, defined by asymmetry parameter η. Therefore the nuclear quadrupole coupling constant e²Qq and the asymmetry parameter η, which contains structural information about a molecule, may be calculated from experimental data.

The main spectral parameters of concern in NQR experiments are the transition frequencies of the nucleus and heir associated line widths Δf. Besides these parameters, obtaining spin-lattice relaxation time T₁, spin-spin relaxation time T₂ and line-shape parameter T₂* (which is inversely proportional to Δf) are also of great value. These parameters must also be taken into consideration when choosing the particular experimental technique and equipment to be adopted.

Applying a strong RF field at the resonant frequency interacts with the nuclear magnetic moment of a nucleus, which is coupled to the electric quadrupole moment, causing it to be disoriented with respect to its equilibrium position. Realignment of this moment after the RF field has been removed causes the generation of a small RF signal, which can be detected by the induced oscillating voltage on an RF antenna.

The signal voltage measured from an NQR sample is typically very small and is susceptible to noise interference. This noise interference may originate from external sources such as radio transmitters, internal noise from the machine's electronics, or the sample contained within the machine.

The signal-to-noise ratio (SNR) of an NQR signal as measured by an NQR detector depends on several parameters and factors:
(i) the mass of the sample irradiated for NQR signal detection,
(ii) the loaded Quality factor (O) of the coil system,
(iii) noise interference (external & internal),
(iv) the filling factor or volume of the coil relative to the sample,
(v) relaxation parameters of the signal,
(vi) conductive and dielectric materials inside the coil,
(vii) the number of signal averages,
(viii) power input to the coil (and hence magnetic field strength),
(ix) ring down time,
(x) the particular signal processing technique employed to extract or identify the NQR signal from noise.

An operator of a practical NQR system has only a very small amount of control over (i), (iv), (v), (vi), (vii) (by virtue of these all being time limited), and (viii) (by virtue of this being power limited to avoid damage to electronic items). Among the few parameters left is the Quality factor (Q) of the coil receiving system and the control of noise interference.

Some external interference may be eliminated by using a shield and a wave-guide beyond cutoff. Further, a single turn copper sheet coil may be used for NQR detection.

This type of coil is useful for the detection of illicit substances in luggage and large mail items and is better than using spiral coils or meanderline coils. Both of the latter coil designs suffer from low Q factors as compared to a single turn coil sheet. The spiral and meanderline coils also suffer from the fact that they emit RF fields on both sides of the spiral or meanderline, hence they waste power irradiating into a non-usable volume. Furthermore, large spiral coils with many turns also have high inductances, which means they will be self resonant at frequencies which are below or close to the frequency of interest, making them unsuitable for NQR detection of large volume packages. Large solenoidal multi-turn coils also cannot be used for large volume package scanning because their inductances are too high, and typically they will be close to or will self resonate at the frequencies of interest.

It is generally considered that the maximum Q should be obtained to maximise the SNR when detecting NQR signals. In this respect, the Q obtained from a single turn solenoid is greater than Q's obtained from most other coil designs known in the art, which means that the single turn coil is the better type of coil design to use for detecting NQR signals compared to these other coil designs.

Despite the single turn coil having benefits over previous coil designs, it is believed that further improvements can be achieved by adopting another coil design, which is the subject of the present invention.

### DISCLOSURE OF THE INVENTION

It is an object of the present invention to provide for further improvements in the detection of phenomenal signals in the art of nuclear or electronic resonance detection technology by using an alternative design of coil than hitherto known in the art.

It is a preferred object of the invention to provide for an alternative coil design that has particularly utility for the detection of an NQR signal in NQR detection systems.

In accordance with a first aspect of the present invention, there is provided a transmit-receive antenna for detecting phenomenal signals using nuclear and electronic resonance detection technology, comprising a plurality of coils connected in parallel, each circumscribing a target volume for irradiating and receiving electromagnetic energy therein to detect the phenomenal signals.

Preferably, the antenna is arranged to be partially transparent to orthogonal magnetic fields.

Preferably, segments of each coil have width and spacing arranged so as to increase field homogeneity across the coil.

Preferably, the coil segments are shaped to increase the Q of the total coil system by using a larger surface area than merely a single sheet coil.

Preferably, the coil segments are disposed so as to produce a magnetic field that lies in an off-axis direction.

Preferably, the segments are discrete to enable signals to be separately decoupled. In this manner, the signal can be measured through each individual loop.

Preferably, the resonance of the antenna is broadened by tuning individual segments of the coil to different transmit frequencies.

Preferably, a switch or mechanical means is provided to add in extra coil segments so as to increase the length of the transmit-receive antenna to accommodate extra large scan items.

Preferably, extra coil segments are used to inductively tune the antenna by moving coil segments.

Preferably, signals that are orthogonal to the central axis of the antenna are measured by using an additional coil.

In accordance with a second aspect of the present invention, there is provided an outer electromagnetic shield for housing a transmit and receive antenna assembly for detecting phenomenal signals using nuclear and electronic resonance detection technology, the shield having a central screen portion, a pair of waveguides disposed at opposing ends thereof, and a pair of sloping channel portions interconnecting the waveguides and screen portion, wherein said screen portion, waveguides and channel portions are shaped to confine the magnetic field emanating from the transmit-receive coil, therein.

Preferably, the waveguides taper marginally inwardly from the inner end thereof to the outer end thereof, and the sloping channel portions comparatively slope more steeply inwardly from the opposing ends of the central screen portion to the inner ends of the waveguides, whereby the cross-sectional area of the inner ends of the waveguides is substantially smaller then the cross-sectional area of the opposing ends of the screen portion, and in turn the cross-sectional area of the outer ends of the waveguides is smaller than the cross-sectional area of the inner ends thereof.

In accordance with a third aspect of the invention, there is provided an electric field shield for shielding specimens disposed within a transmit and receive antenna assembly for detecting phenomenal signals using nuclear and electronic resonance detection technology from the electric field of the antenna, comprising an inner conductive sleeve to be disposed in close proximity to the antenna within the target volume circumscribed thereby and in electrical isolation therefrom.

Preferably, the electric field shield is disposed around the inside of the coil to reduce the spatial dimensions of the electric field of the coil and direct the electric field away from the item being scanned. This prevents coupling between the electric field and the item being scanned, and it also stops the electric field signals being coupled back into the transmit-receive antenna.

Preferably, the conductive sleeve comprises a plurality of conductive strips extending axially of the antenna when disposed therein, said conductive strips being transversely spaced apart.

Preferably, the electric field shield also has an outer conductive sleeve, transversely spaced from said inner conductive to define an axially extending gap for situating the antenna therein.

In accordance with another aspect of the present invention, there is provided an antenna and shield apparatus for detecting phenomenal signals using nuclear and electronic resonance detection technology, comprising:
a transmit and receive antenna as defined in the first aspect of the invention;
an outer electromagnetic shield housing the transmit and receive antenna as defined in the second aspect of the invention; and
an electric field shield for shielding specimens disposed within said transmit and receive antenna assembly, as defined in the third aspect of the invention.

### BRIEF DESCRIPTION OF THE DRAWINGS

FIG. 1 shows a diagram of the multiple parallel loop transmit-receive coil, where four sheet ‘segments’ are joined in parallel in accordance with the first embodiment.

FIG. 2 shows a perspective view of the electric field shield design in accordance with the first embodiment.

FIG. 3a is a cross-sectional view of the electric field shield of FIG. 2; and

FIG. 3b is a cross-sectional view of a variation of the electric field shield used in the first embodiment.

FIG. 4 is a side elevation of a schematic drawing of the outer shield of the antenna and shield apparatus in accordance with the first embodiment.

FIG. 5 is a plan sectional view showing a schematic of the coil assembly within the outer shield, according to the first embodiment.

FIG. 6 shows orthogonal detection of spurious and/or NQR signal using a first set of orthogonal coils in accordance with the second embodiment.

FIG. 6a shows orthogonal detection of spurious and/or NQR signal using a second set of orthogonal coils in accordance with a variation of the second embodiment.

FIG. 7 shows alternative coil assembly that provides inductive tuning by extending the outer segment of the multiple parallel loop transmit-receive coil in accordance with the third embodiment.

FIG. 8 shows another form of multiple parallel loop transmit-receive coil, with the segments configured to act as individual transmit-receive coils in accordance with the fourth embodiment.

FIG. 9 is shows a variation of the coil assembly design of FIG. 8 to mitigate coupling.

FIG. 10 is a perspective view of a coil assembly using relays in accordance with the fifth embodiment; and

FIG. 11 is a circuit diagram of the coil system of FIG. 10.

FIG. 12 is a perspective view of another coil assembly using relays in accordance with the sixth embodiment;

FIG. 13 is a circuit diagram of the coil system of FIG. 11.

FIG. 14 shows the extended multiple parallel loop transmit-receive coil in accordance with the seventh embodiment.

FIG. 15 is a perspective view of a coil assembly for improved field homogeneity in accordance with the eighth embodiment.

FIG. 16 is a perspective view of an alternative coil assembly for improved field homogeneity in accordance with the ninth embodiment.

FIG. 17 shows a graph of the magnetic field (B) profile down the central axis of a modified multiple parallel loop transmit-receive coil in accordance with the ninth embodiment.

FIG. 18 shows a of the multiple parallel loop transmit-receive coil, which generates a uniquely shaped magnetic field, in accordance with the tenth embodiment. The 90° bend half way down the segments of this coil will produce an orthogonal field.

FIG. 19 is a view of a modified coil assembly in accordance with the tenth embodiment.

FIG. 20 shows a diagram of the multiple parallel loop transmit-receive coil, where four pipe ‘segments’ are joined in parallel in accordance with the eleventh embodiment.

FIG. 21 is a perspective view of an alternative coil assembly formed of wire in accordance with the twelfth embodiment.

FIG. 22 is a perspective view of a further variation on the coil assembly to provide an improved homogeneous field in accordance with the fourteenth embodiment.

FIG. 23 shows an alternative coil assembly design using pipes for the orthogonal detection of spurious and/or NQR signal using a second set of orthogonal coils in accordance with the fifteenth embodiment.

FIG. 24 shows the pipe configuration of the multiple parallel loop transmit-receive coil to achieve inductive tuning by extending the outer segment of the coil in accordance with the sixteenth embodiment.

FIG. 25 shows the pipe configuration of the multiple parallel loop transmit-receive coil, with the segments configured to act as individual transmit-receive coils in accordance with the seventeenth embodiment.

FIG. 26 shows the pipe configuration of the extended multiple parallel loop transmit-receive coil in accordance with the eighteenth embodiment.

FIG. 27 shows the pipe configuration of the multiple parallel loop transmit-receive coil, which generates a uniquely shaped magnetic field, in accordance with the nineteenth embodiment. The 90° bend half way down the segments of this coil will produce an orthogonal field.

FIG. 28 is a perspective view showing an alternative E field shield design in accordance with the twentieth embodiment.

FIG. 29a is a cross-sectional view illustrating the shape of the electric field in a standard rectangular single turn, slot coil, which forms the outside of the second E field shield design of FIG. 28.

FIG. 29b is an end view of the second E field shield design shown in FIG. 28.

### BEST MODE(S) FOR CARRYING OUT THE INVENTION

The best mode for carrying out the invention is directed towards an antenna and shield apparatus forming part of an NQR detection system. The NQR detection system incorporates an NQR scanner particularly adapted for detecting NQR signals emitted from a substance containing particular quadrupole nuclei. The substance is unobtrusively sought to be identified from within a specimen that is brought into the confines of a target volume and irradiated with electromagnetic energy to bring about the emission of the NQR signals, if the substance is present.

Those skilled in the art of NQR will recognise that the objective in designing an NQR scanner is to efficiently convert electrical energy from an RF transmitter into a magnetic field. This field should be spatially uniform and of sufficient intensity (in the order of G) to excite the required NQR response from a sample. Further, by the principle of reciprocity—reciprocity in this context means irradiating an NQR sample with a signal and receiving the NQR response signal with the same coil—this system can, under the right circumstances, be very efficient for detecting the NQR response. Reciprocity is the most efficient method of receiving a signal from an NQR sample. Using a separate transmit-receive system will generally result in inferior results.

The antenna and shield apparatus that constitutes the best mode for carrying out the invention can be broken down into three principal components:
(1) the main transmit and receive antenna assembly (“the coil assembly”),
(2) the electric field shield, and
(3) the outer shield.

A fourth component that substantially increases the utility of the antenna and shield apparatus is the provision of a multipurpose electrically orthogonal coil.

Each of these components represent an improvement or development in the art of antenna and shield apparatus design for NQR scanners and hence will be described in principle first, before describing several specific and different embodiments that may be adopted for carrying out the best mode of the invention, or variations thereof.

The coil assembly in the context of the present invention, is best dubbed a ‘multiple parallel loop transmit-receive antenna’.

The coil assembly essentially comprises a coil consisting of a number of loop segments formed of an electrically conducting material that are connected in parallel by connectors to form a first set of coils.

A further set of coils are orthogonally arranged relative to the loop segments of the first set of coils The orthogonal arrangement of the further set of coils makes it possible to monitor orthogonal interferences and process signals representative thereof to enhance the detectability of any NQR signal.

Accordingly, the resultant network of coils is designed to permit signals which are approximately orthogonal to the normal orientation of signals during the scanner's excitation/receive mode, to traverse through the body of the first set of coils and be detected by the further set of mounted electrically orthogonal to the first set of coils.

NQR is a strictly magnetic coupling with the nuclei that have an electric quadrupolar moment. However, the coil assembly can produce considerable electric fields (E field). These electric fields are undesirable for a number of reasons obvious to those skilled in the art. For example, these fields can excite unwanted phenomena such as piezo-electric ringing within certain susceptible materials. The electric field may also couple to the item being scanned and cause resistive losses, which affect the sensitivity of the coil. Also, by the principle of reciprocity, certain parts of the coil assembly are particularly sensitive to electrical interference, which may be caused by an oscillating E field due to electrical items within the enclosure of the scanner.

The electric field shield is provided to shield the specimen in the target volume of the NQR scanner from the effects of the electric field produced by the coil assembly. It achieves this goal by being an impenetrable metallic shield disposed between where the electric field is generated and the specimen being scanned. The electric field shield also does not form a closed current loop which could oppose the B field generated by the coil assembly otherwise the coil would be unusable.

The outer shield essentially serves two purposes. First and most obviously it shields the coil assembly from external electromagnetic interference by using a waveguide and a conductive metal screen. However, just as significantly the shield is responsible for guiding the magnetic field lines generated by the coil around a confined path. Thus, the objective in the shield design is to choose the geometry and the shield materials to minimise losses due to currents induced in the shielding enclosure and to guide the field lines back to the coil assembly in the most efficient manner.

The best mode for carrying out the invention will now be described by way of a number of different embodiments.

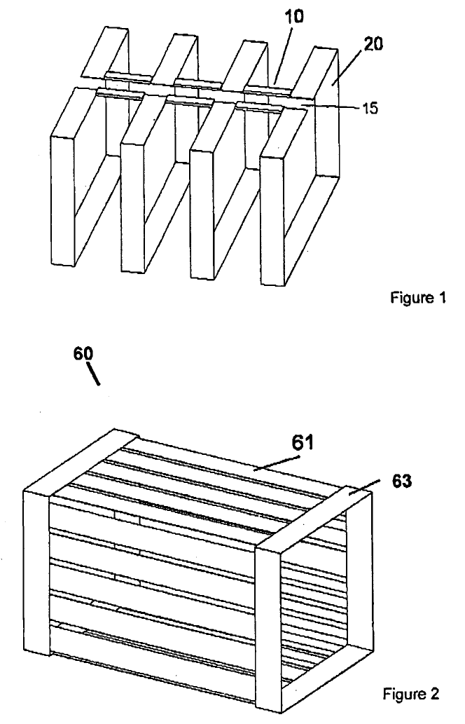

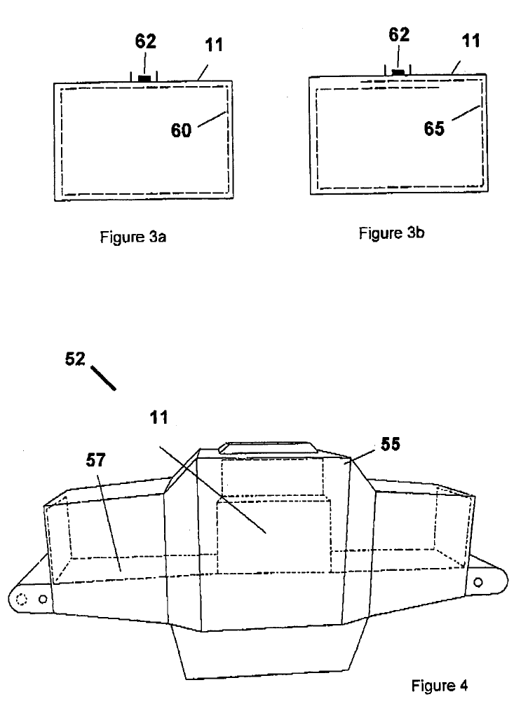

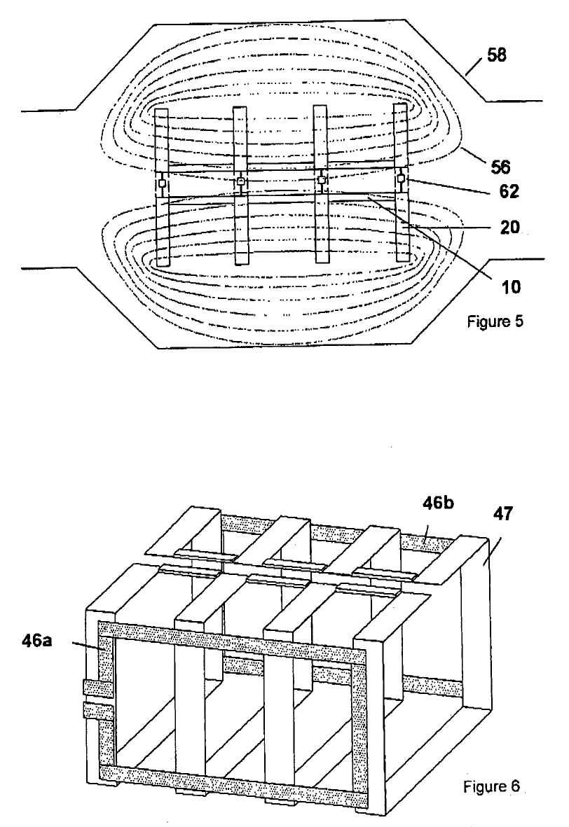

The first embodiment is directed towards an antenna and shield apparatus comprising a coil assembly 11 of the type shown in FIG. 1, an electric field shield 60 of the type shown in FIGS. 2 and 3a, and an outer shield 52 of the type shown in FIGS. 4 and 5.

The coil assembly 11, as shown in FIG. 1, comprises a plurality of loop segments 20 made out of flat sheet electrical conducting material. The loop segments 20 are axially spaced in parallel alignment with each other about a central axis to constitute a first set of coils. Each of the loop segments 20 is interconnected along its top by a series of connectors in the form of bars 10 made from an electrically conducting material.

The loop segments 20 are configured in a rectangular shape in cross-section circumscribing a target volume within which a specimen may be disposed for scanning.

The opposing ends of each loop segment 20 at the top of the coil assembly 11 are spaced from each other to define a gap 15 within which may be disposed a plurality of switching capacitors 62 (shown in FIGS. 3a and 5) that may be selectively switched into and out of the coil circuit to variably tune the coil assembly to a desired resonance frequency for detection purposes. This will be described in more detail later with respect to other embodiments of the invention.

Although the loop segments 20 of the coil assembly in the present embodiment are configured rectangularly, in other embodiments of the assembly the cross-sectional shape could be an ellipse, circle, polygon or any shape, which may match the specimen being scanned.

The electric field shield 60, as shown in FIGS. 2 and 3a of the drawings, has an inner sleeve comprising a plurality of conductive strips 61 of metal disposed parallel to the length of the coil assembly and to the gap 15 into which the capacitors 62 are placed. The electric field shield 60 is disposed within the target volume of the coil assembly, as shown in FIG. 3a, in close but isolated proximity to the loop segments 20. The advantage of this arrangement is that shielding of the electric field for a single turn coil assembly is provided, as well as for a multi-turn coil assembly.

The conductive strips 61 are perpendicular to the opening of the coil assembly and are retained in place by an insulator material 63 simply used to hold the conductive strips in place. Items to be scanned such as luggage would pass inside the conductive strips 61, where the electric field is diminished by these conductive strips within the scan volume, but the magnetic field is unaffected by the conductive strips because the strips cannot oppose the magnetic field.

Two different configurations of this particular type of electric field shield may be provided for in carrying out the invention. In the present embodiment, the electric field shield 60 has the strips 61 configured, when viewed in cross-section as shown in FIG. 3a, to form a loop. In an alternative embodiment, as shown in FIG. 3b, an electric shield 65 has the strips 61 configured to overlap at the top of the coil assembly 11, directly underneath where the capacitors 62 are placed, thereby forming an open loop, but providing double insulation of the electric field at this position if required.

The outer shield 52 of the present embodiment, as shown in FIGS. 4 and 5, essentially comprises a central conductive metal screen portion 55, a pair of waveguides 57 adjacent opposing ends of the metal screen portion, and a pair of sloping channel portions 58 interconnecting the metal screen portion 55 and the waveguides 57.

The metal screen portion 55 has openings at opposing ends thereof contiguous with the sloping channel portions 58 to and defines a central chamber within which the coil assembly 11 and electric shield 60 are disposed.

The waveguides 57 each having openings at opposing ends thereof of smaller cross-sectional area than the openings of the metal screen portion 55, with one opening being formed contiguously with the adjacent outer end of the sloping channel portion, and the other opening disposed to define the outer opening of the outer shield 52 itself. The sides of the waveguides 57 are tapered marginally inwardly extending from the inner opening thereof towards the outer opening, thereby making the outer opening smaller in cross-sectional area than the inner opening thereof.

The sides of the sloping channel portion 58 are more steeply tapered than the waveguides 57 to more accurately follow the lines of the magnetic field 56 produced by the coil assembly 11, as shown in FIG. 5.

The openings of the various portions making up the outer shield 52 are axially aligned to define a central passage passing through the outer shield. In the final scanner design, this passage provides for a conveyor belt 59 to be disposed therealong and integrated with the antenna and shield apparatus, allowing for postal, luggage or baggage specimens to be conveyed into the target volume of the coil assembly 11 disposed within the central chamber, and surveyed for NQR signal detection.

It should be noted that the shape of the outer shield 52 is particularly important. Although FIG. 5 shows a top view of the shielding geometry, a side view of the shielding geometry would look identical. The illustrated shape of the outer shield 52 has been found to be particularly effective for the coil assembly 11 design adopted in the present embodiment. The advantage of the outer shield design in this embodiment is that the shape of the outer shield 52 helps further guide the magnetic field lines from one end of the coil assembly 11, back to the other end of the coil assembly. As they emanate from the coil assembly, the magnetic field lines 56 are perpendicular to the orientation of the loop segments 20 of the coil. As the lines 56 approach the waveguide structure near the ends of the outer shield they are deflected 900 towards the shield wall, as opposing currents generated in the waveguide 57 create an opposing magnetic field. On approaching the sloping sides of the shield wall channel portions 58, the magnetic field lines are gently bent and guided back towards the other end of the coil assembly, thus minimising losses in the shield.

In the present embodiment, the shape and spacing of the outer shield around the coil was optimised via numerical modelling techniques.

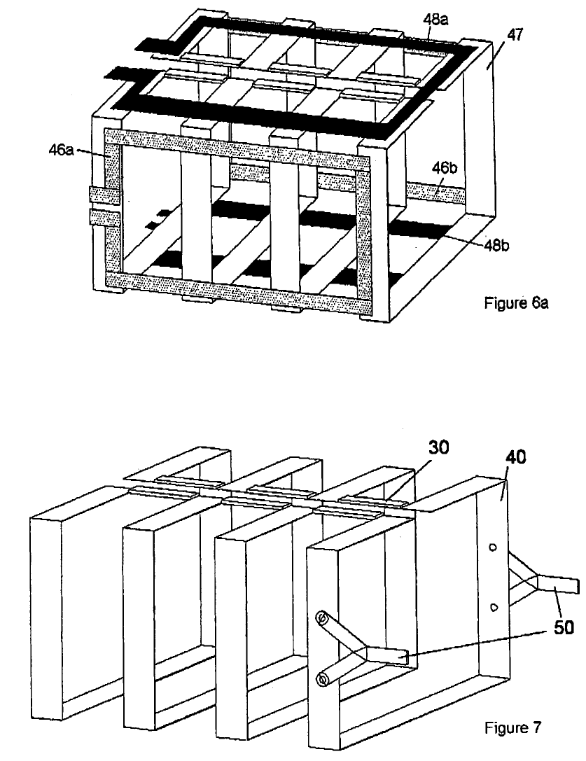

The second embodiment for carrying out the invention is substantially the same as the first embodiment, except that it includes an orthogonal coil design, as shown in FIG. 6 of the drawings, to constitute the multipurpose electrically orthogonal coil referred to in the best mode for carrying out the invention.

Moreover, in the coil assembly 45, a set of orthogonal coils is mounted to the sides of the coil assembly to constitute a second set of coils. The second set of orthogonal coils comprise a pair of flat sheet coils 46a and 46b, each coil being respectively mounted on either side to the loop segments 47.

In this embodiment, the coil assembly 45 provides excitation to a specimen located within the target volume circumscribed by the loop segments 47 constituting the first set of coils. After the transmit pulse has been removed and dead time has elapsed, the second set of coils that are orthogonally arranged, comprising the orthogonal coils 46a and 46b, are then activated to detect any signal possibly due to magnetoacoustic ringing, noise from electronic items inside the coil or piezoelectric ringing. These induced signals are then subtracted or simply used to show that the signal detected in the coil is probably from one of these interfering sources.

The purpose of these orthogonal coils is manifold. For example, the orthogonal coils can detect spurious signals, such as ringing sources and internal electrical interference sources. In addition, or alternatively, they can detect and/or excite a second NQR response.

In the case of spurious ringing and electrical interference sources, the signal amplitudes may be many orders of magnitude greater than the NQR response. Under many circumstances coherent averaging and signal processing techniques can eliminate electrical interference. However, if the source is too intense these techniques may not be sufficient to eliminate this problem and under these circumstances the second set of coils can be used to veto or even partially remove this source of noise.

Ringing sources also can be dealt with by the use of special pulse sequences, however, if the source is again too intense, using the second set of coils for orthogonal detection can help to either veto or balance out the spurious signal.

Due to the fact that these spurious signals are often very large, it is possible to detect them over a wide variety of coil geometries even if the spacing between the coils is quite small relative to their width. For example, even a 2 mm gap between the coils will improve the detectability of spurious interferences by 10 dB. Accordingly, other orthogonal coil designs may be provided, some of which are the subject of further embodiments of the present invention.

An enhancement of the present embodiment is shown in FIG. 6a, whereby a third set of coils 48a and 48b is mounted, one coil 48a to the top of the loop segments 47, and the other coil 48b to the bottom of the loop segments, and operated in such a way as to improve the monitoring of orthogonal interferences even further.

The third embodiment is substantially the same as the first embodiment, and is shown in FIG. 7. In this embodiment, the connectors between the loop segments are formed of conductive wire 30, which is flexible. The advantage of this arrangement is the ability to move all of the loop segments forming the coils, or just the outer loop segment 40, so that inductive tuning can be performed.

Ordinarily in the art of tuning an NQR coil, additional capacitors are switched into the circuit to change the resonance frequency of the coil system. Movement of the coil segments outwards will lower the inductance of the entire coil. Thus, if the capacitors connected into the coil circuit are unchanged, there will be a change in the resonance frequency of the coil. Consequently, it would then be possible to fix the capacitor values and tune the coil inductively instead of capacitively. This is advantageous as switching in capacitors often increases the resistance of the coil-capacitor system which in turn lowers the Q of the system. By lowering Q, the signal to noise ratio will drop and hence the detection rate will be lower. By inductively tuning the coil, the system has no extra resistance being switched in and hence the Q should remain the same when tuning the coil.

As shown in FIG. 7, the outer loop segment 40 can be mechanically moved by non-conductive arms 50 to a new position. The arms 50 are connected to a motor drive (not shown) such as a stepper motor which is located well away from the coil so it does not affected its electrical properties and does not interfere with the magnetic field that circulates between the coil and the outer electromagnetic shield. The motor is also located so that it does not block the entrance of scan items into the coil area.

The arms 50 are constructed out of a material which is sufficiently strong so as not to break after many movements of the outer loop segment 40. The connection 30 between the outer loop segment 40 and the next loop segment is made out of a flexible material such as thick copper braided wire, so the outer loop segment 40 can be moved.

In a variation of the present embodiment, the connection 30 alternatively is made out of two pieces of conductive material (not shown), which slide over each other to maintain electrical contact.

Furthermore, by adoption of the present embodiment, it may be possible to use both inductive and capacitive tuning if the application required it.

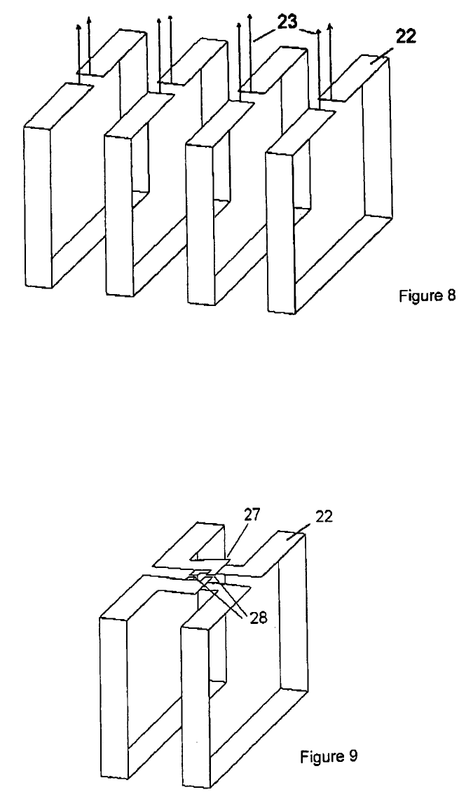

The fourth embodiment is substantially the same as the first embodiment, but without any orthogonal detection. Moreover, in this embodiment the connectors are entirely removed, as shown in FIG. 8. The advantage of this arrangement is to enable spatial visualisation, broaden the frequency range of the transmission and receiving, individually receive signals and combine only those that contain an NQR-like signal.

In the present embodiment it is possible to transmit and receive signals in the loop segments separately rather than being one coil made of multiple coils coupled together. As shown in FIG. 8, individual loop segments 22 are excited at the same or different frequencies by means of connections 23 to a transmit power amplifier. By irradiating and receiving the signals in individual coils it is possible to spatially visualise where the signal originates from in the volume of interest, by analysing the signals received separately and determining which coils contain signals of interest. It may also be possible to examine the signal received from each coil and only average or combine those signals that contain signals of interest. This would increase the signal to noise by not adding unwanted noise.

In an enhancement of the present embodiment, the coupling between individual coil segments can be overcome by modifying the loops as shown in FIG. 9. Neighbouring loop segments 22 are extended to create a loop section 27 near the top of each coil, which is perpendicular to the main coil assembly. The two extended loops 27 from neighbouring coil segments 22 are allowed to overlap. The overlapping, if arranged correctly, will cause the two loops to be decoupled from each other resulting in the coils being able to be used for the purposes previously described. Capacitors to resonate the coils (not shown) are placed in the gaps 28.

It is also possible to tune the individual coil sections such that the frequency bandwidth over which the coil irradiated could be increased without lowering the Q of the system. One of the problems with scanning NQR samples are temperature effects. These cause the resonant NQR frequency to drift with temperature, where the frequency temperature relationship is approximately linear at room temperature for most explosives. By tuning individual segments to slightly differing frequencies the temperature problem can be overcome by ensuring all possible NQR frequencies for the substance of interest that occur between 0-40° C. are irradiated. The use of such a system also negates the use of two or more pulse sequences at differing frequencies to irradiate the sample to overcome the temperature problem. The use of only one pulse sequence will result in a saving of time, which is crucial in time limited measurements, such as baggage scanning. Furthermore, when using two pulse sequences there is the possibility of partially exciting a substance on the edge of the frequency bandwidth of the pulse. If the relaxation time required is long between pulses for this substance then it may be possible that this substance will not be detected when using two pulse sequences at different frequencies. However using only one pulse sequence and using a wide frequency bandwidth slot coil will result in detection if the substance of interest is present.

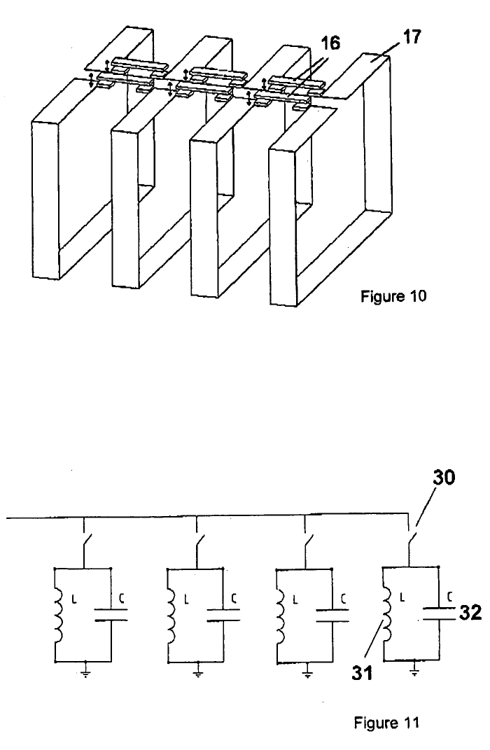

The fifth embodiment is substantially the same as the first embodiment, but again without orthogonal detection. In this embodiment, as shown in FIGS. 10 and 11, the connectors interconnecting the loop segments 17 are switches 30 in the form of relays 16. The advantage of this embodiment is the ability to switch between individual receivers, represented by the LC circuit 31, 32, and a single turn coil.

Using switching relays 16 enables the multi loop antenna to be switched between a state of being a single turn coil with all switches 30 closed, and separate multiple loop antennas, with the switches 30 opened. This will be an advantage if only one power source was available. Hence the coil assembly could be irradiated in the state of a single turn coil and then switched into a state of individual receivers for the receiving phase of the measurement.

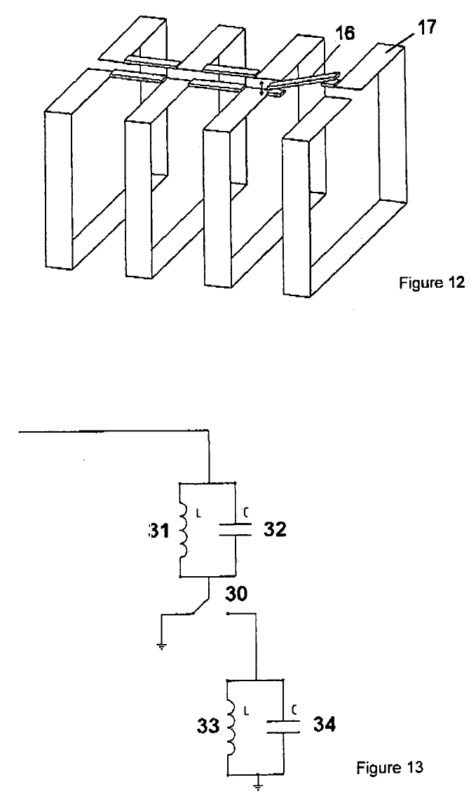

The sixth embodiment is substantially the same as the fifth embodiment except that the relays 16 enable the coil assembly to be switched into a two or higher turn coil. This is shown in FIGS. 12 and 13. The advantage of this arrangement is the ability to measure one substance with a single turn loop coil, represented by the LC circuit 31 and 32 in FIG. 13, then switch at 30, and then measure a second substance at a different frequency, using an extended loop segment 17 represented by the LC circuit 33 and 34.

The extended loop segment could be connected in series rather than parallel. This would result in the multiple parallel loop coil becoming a 2 turn coil, raising the inductance and strength of the magnetic field inside the coil assembly, which may aid in the detection of illicit substances.

By connecting even more segments in series, the multiple parallel loop coil would become a higher turn coil. The advantage of having multiple turns is that, as well as extending the length of the coil assembly, the coil's inductance becomes higher, which lowers the amount of capacitance required to resonate the coil at a specific frequency.

The lowering of the amount of capacitance required results in four advantages. Firstly, the ceramic chip capacitors typically used to resonate coils are expensive, which means the device can be manufactured at a lower cost. Secondly, smaller coils, suitable for scanning postal items, have very low inductance and it is advantageous to raise the inductance of these coils to a level where it is easier to resonate the smaller coil. Thirdly, the best noise match may be obtained at a specific inductance of the coil, so being able to alter the inductance will help in the raising the SNR of the NQR detector. Fourthly and most importantly, the coil can be arranged such that scanning a substance at a high NQR frequency can be performed, and then by switching in extra inductance, it is possible to scan a much lower frequency substance without the requirement of adding in large amounts of capacitance. An example here would be scanning a 5 MHz line of one substance and then by switching to a 2 turn configuration the 1 MHz line of another substance could be scanned, without excessive amount of capacitance being switched into the circuit.

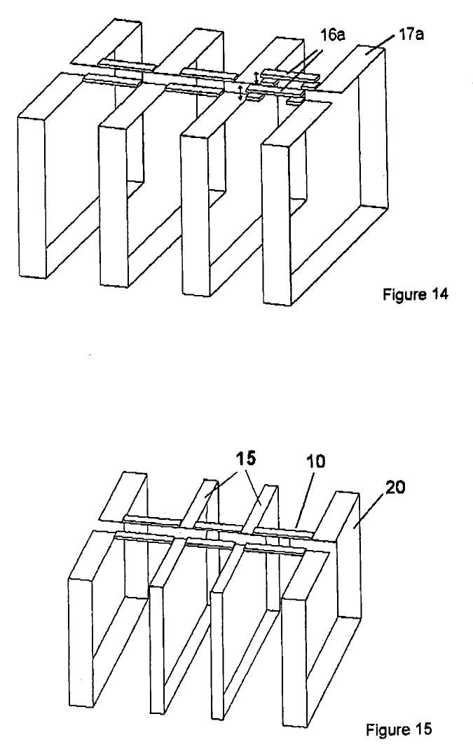

The seventh embodiment is substantially the same as the fifth embodiment except that, as shown in FIG. 14, an extra relay 16a is added to the outer loop segment 17a, or loop segments, such that the effective length of the coil assembly is increased or shortened to match the size of the bag being measured.

The advantage of this arrangement is that it is possible to match the size of the bag to the coil size, i.e. increasing sensitivity and ensuring the entire bag is scanned. This means the scanner can accommodate oversized items and the scan volume is then also well matched to the bag being scanned.

The outer coil segment 17a in FIG. 14 is normally open circuit until it is required for scanning a long piece of luggage. The switches 16a are then closed and the outer segment 17a is made a closed circuit. The outer segment 17a will then irradiate a magnetic field and hence also be able to receive an NQR signal from the item under inspection. When the extra segment 17a is not required, both switches 16a are open and the outer segment is also open circuit, so that the outer segment doesn't interfere with the normal operation of the coil. If the outer segment was left closed circuit then this outer segment would interfere with the operation of the coil, by lowering inductance and increasing resistance of the main coil, resulting in a low Q factor and consequently a poor detection rate.

The number of coils in FIG. 14 that are switchable doesn't neccesarily have to be only one, for instance multiple loops could be switched into the circuit according the length of the item under inspection.

The eighth embodiment is substantially the same as the first embodiment, without provision for orthogonal detection and the width of the sheet loop segments are varied. The advantage of this embodiment is that the homogeniety of the magnetic field is improved allowing equal probability of detection across the length of the coil.

As shown in FIG. 15, the width of loop segments 20 in FIG. 1 is adjusted such that the width of the inner loop segments 15 are very narrow and the width of the segments 20 near the ends of the coil are very large.

In a normal single turn coil, the eddy current effect causes the current to flow mostly around the ends of the coil, as this is the site of least resistance to current flow in the coil. This effect results in a fairly uniform magnetic field across the single turn coil and thus making it suitable for scanning large packages.

In the present embodiment, the wider end segments 20 and narrow inner segments 15 further bias the current to flow through the outer segments and therefore creating an even more uniform magnetic field down the central axis of the coil. A highly uniform magnetic field within the scan area ensures that illicit substances located near the ends of the bags will be irradiated with same strength magnetic field as those located in the centre of the scan area and therefore the signal strength will be the same regardless of the location of the illicit substance within the scan area.

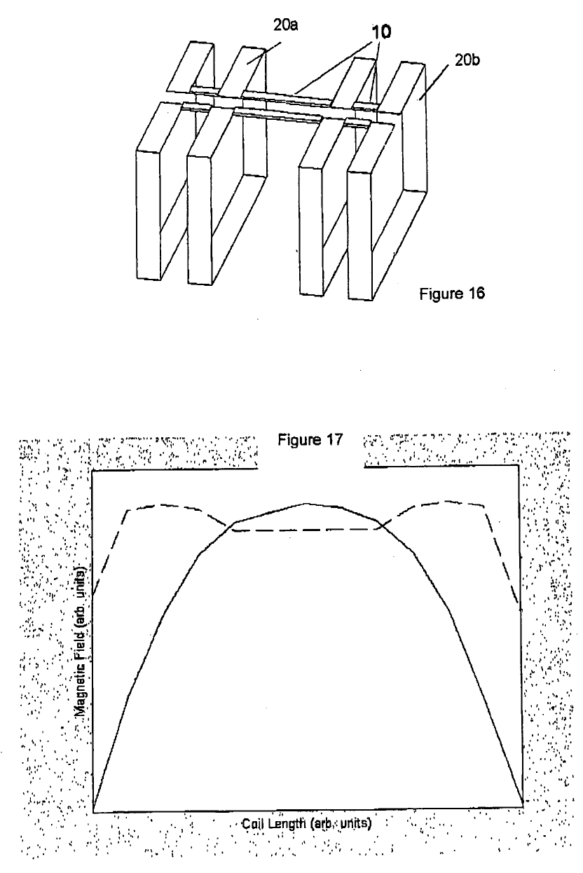

The ninth embodiment is similar to the preceding embodiment in achieving the same effect of field homogeneity by varying the separation or gap between each loop segment. As shown in FIG. 16, the loop segments 20a in the centre of the coil have large gaps between them and loop segments 20b near the ends have very narrow gaps between them.

To illustrate the improvement in field homogeneity a multiple parallel loop coil was modelled in an electromagnetic field simulator using the finite element method. The coil consisted of three basic cylindrical segments connected together. The two outer segments were 50 mm long and the centrally located inner segment was 30 mm long, with a 235 mm gap between the outer and inner segments, making a total coil length of 600 mm. FIG. 17 shows the simulated B field down the central axis of this cylindrical shape and an ordinary single turn coil. As it can be seen in FIG. 17 the field from this coil (dashed line) is almost homogeneous across the length of cylinder whereas the field from a single turn coil (solid line) is peak shaped. By using this coil, samples located near the edge of the coil can be irradiated with the same intensity as those in the centre of the coil, and thus the response from the sample should be the same regardless of where it is located along the coil's main axis. Off the main axis the field is not as uniform mainly due to the fact there were only 3 segments used in this model. Better results could be obtained if the number of segments was increased to well beyond 20 or 30, all with varying widths, such that the magnetic field would be homogeneous where ever the sample was located within the coil.

The tenth embodiment is substantially the same as the first embodiment, except that the loop segments have a bend in them. The advantage of this embodiment is the creation of an off axial field for a single turn coil, which limits coupling to electronic items.

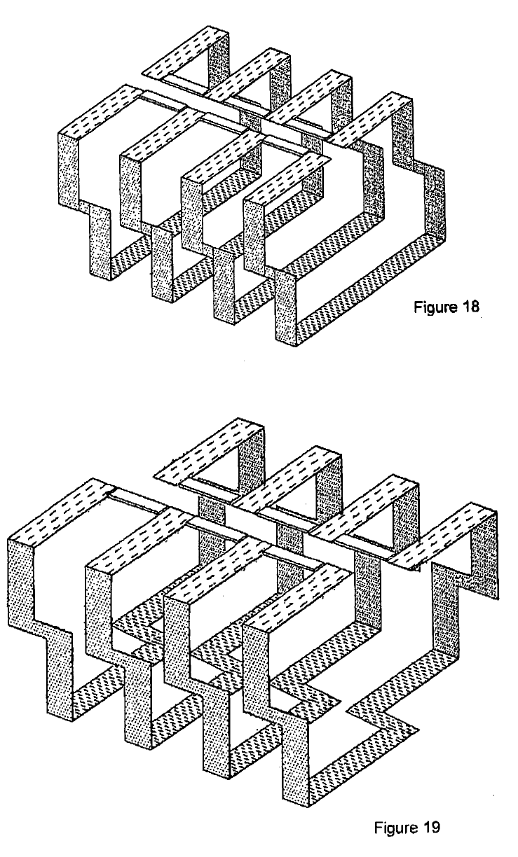

As shown in FIG. 18, it is possible to construct the loop segments such that magnetic field lines lie in an unusual direction for the magnetic field. Ordinarily the magnetic field from a single turn coil is linearly polarised and lies perpendicular to the openings of the coil. In FIG. 18, the segments have been bent at 90° to each other at the half height point of the coil assembly. This will generate a magnetic field that has both horizontal and vertical components at different points within the volume of the coil, because the magnetic field generated is perpendicular to the current flow around the coil. When the current first traverses down a segment it will generate a magnetic field that lies perpendicular to the openings of the coil. When it bends and begins to travel horizontally the magnetic field generated will be parallel to openings of the coil. This uniquely shaped magnetic field gives the advantage of exciting the nuclei in an unusual direction within in the coil.

One of the problems of scanning electronic items within luggage is the interference caused by the induction of unwanted signals within these items. By changing the shape of the coil segments to that of FIG. 18 the direction of the magnetic lines lie at approximately 45° to the horizontal. Tests pursuant to this invention have shown at this magnetic field orientation they are less likely to induce large signals within electronic items, because most electronic items traverse through the machine horizontally and therefore most circuits within these devices will be less influenced by the magnetic field of the NQR detector. The overall result will be a reduction in the false alarm rate.

Another variation of this coil design is to make another bend on the underside and topside of the coil, as shown in FIG. 19. This variation would then produce a magnetic field that utilises the third dimension and thus may help also to further distinguish NQR signals from signals from electronic items. It may also be possible make the bends in FIG. 18 or 19 at any angle which helps to reduce the false alarm effects of electronic items within the coil. The 90° bends do not necessarily have to be at the half height of the coil. For instance, as most luggage has a low profile then it may advantageous to construct the ‘bends’ at just above the base of the coil. The angle to which the segments are bent may also not be necessarily 900, as it may be easier to construct the bend at a shallower angle.

The eleventh embodiment is substantially the same as the first embodiment, but with the sheets now being pipes. The advantage of this arrangement is that the larger surface area provided by a pipe presents a decreased resistance, and hence increases Q resulting in better detection. Pipe also allows a cryogenic fluid to be passed through the coil.

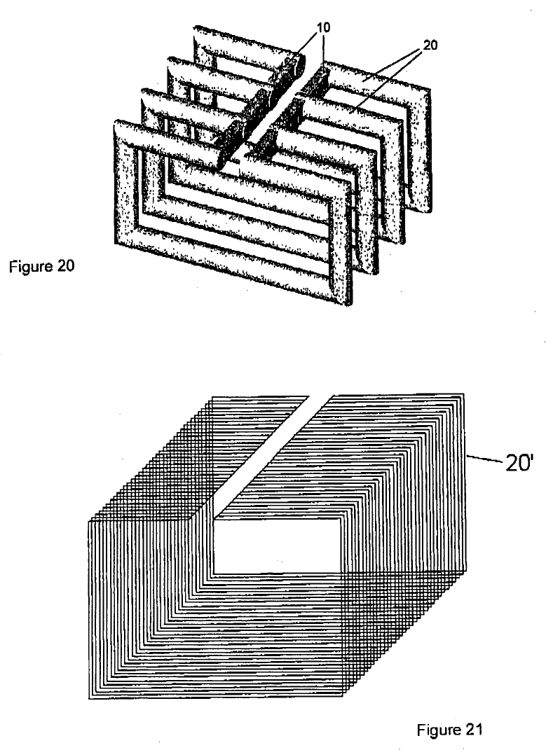

As shown in FIG. 20, the sheet loop segments are replaced by pipe 20′. Although the parallel segments in FIG. 1 are shown to be made of sheet, they could equally be made of conductive pipe. A pipe design enables the current to flow over a greater surface area and, provided all other sources of resistance are minimised, an increase in Q. This increase in Q would result in a increased sensitivity as sensitivity of an NQR spectrometer partially depends on Q of the coil system. This use of pipe has been shown to have a superior Q over flat shaped solenoidal coils. In particular, if the spacing between the pipe loops is 3 times the radius of the pipe loops for a solenoidal coil then the sensitivity is found to be at a maximum. Finally, the use of pipe design allows a cooling fluid to be passed into the coil such that it can be cryogenically cooled. A cryogenically cooled coil will have a low noise floor as compared to a non cooled coil and hence aid in the detection of very small signals.

The twelfth embodiment is substantially the same as the first embodiment, but with the sheet loop segments now being wires. Once again this increases the surface area resulting in a larger Q.

As shown in FIG. 21, the loop segments are now formed of wire 20″ which also offers lower resistance to the current than that observed in a single turn sheet coil of the same size. This lower resistance would translate into a higher Q, which would result in better SNR and thus a better detection rate over a normal single turn sheet coil.

The thirteenth embodiment is substantially the same as the twelfth embodiment, but with the wires being insulated (i.e. Litz wire). This results in increased current carrying capacity resulting in higher Q.

In this embodiment the coil assembly would look substantially similar to that of FIG. 21. In this arrangement, insulated wire (or Litz wire) would also offer lower resistance to the current than that observed in a single turn sheet coil of the same size. This lower resistance would translate into a higher Q, which would result in better SNR and thus a better detection rate over a normal single turn sheet coil.

The fourteenth embodiment is substantially the same as the first embodiment, but with the loop segments that are nearer to the centre having a larger cross-sectional area as compared with the outer loop segments. The advantage of this embodiment is that increased field homogeneity results as compared to a single turn coil.

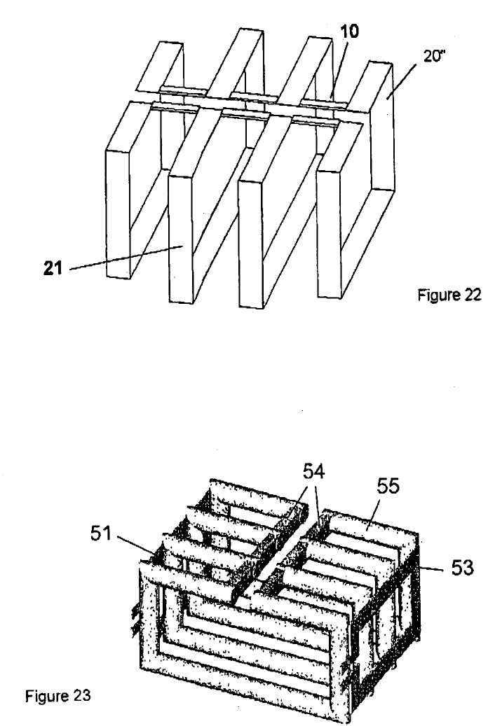

As shown in FIG. 22, the antenna would be constructed with the outer segments of the coil with loop segments 20 such that the opening into which the scan item passes is narrower near the ends of the coil assembly than the middle 21 of the coil assembly. In its most extreme example this design would result in barrel shaped antenna. This design would result in a further improvement in field homogeneity by concentrating the circulating current near the ends of the antenna and consequently improve the magnetic field homogeneity down the axis of the coil.

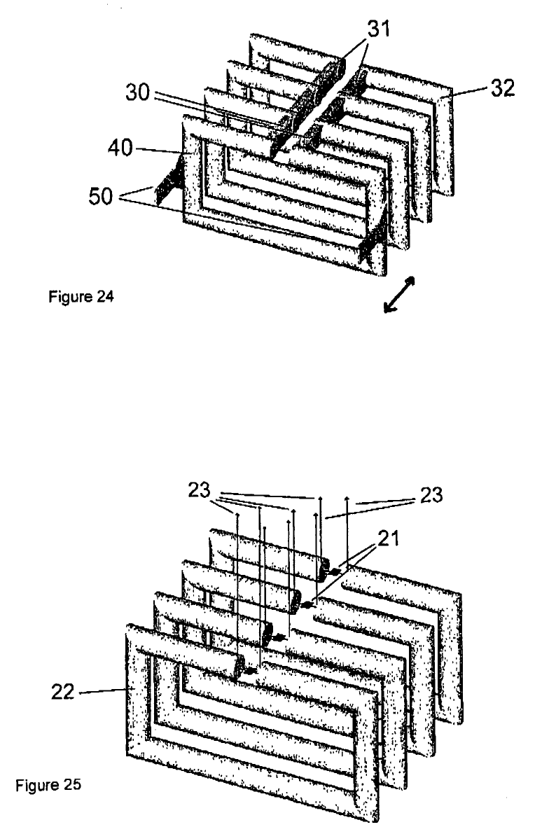

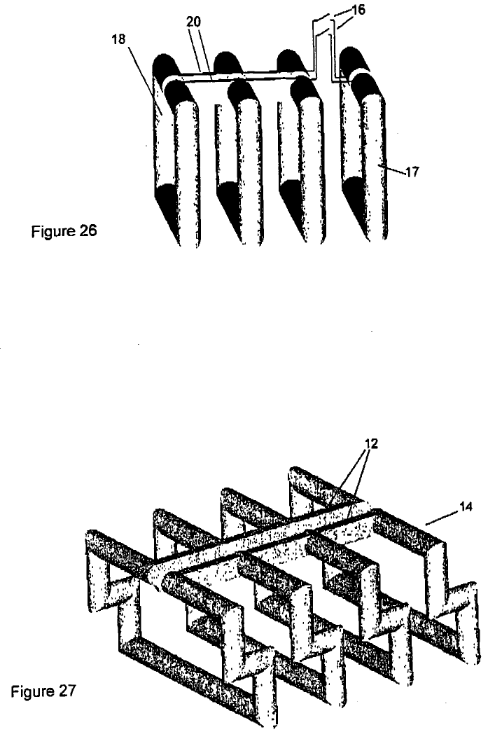

The fifteenth to the nineteenth embodiments combine the pipe design with each of the coil arrangements described in the second to sixth embodiments and the tenth embodiment, respectively, the fifteenth to nineteenth embodiments being illustrated in FIGS. 23 to 27, respectively.

The twentieth embodiment is substantially the same as the first embodiment except that electric field shield has a full sheet of copper, as opposed to strips, wrapped around the inner side of the coil assembly, such that it doesn't connect and thus generate any opposing magnetic fields which would destroy the small NQR signal within the coil. The advantage of this embodiment is that the electric field shield is for a single turn coil.

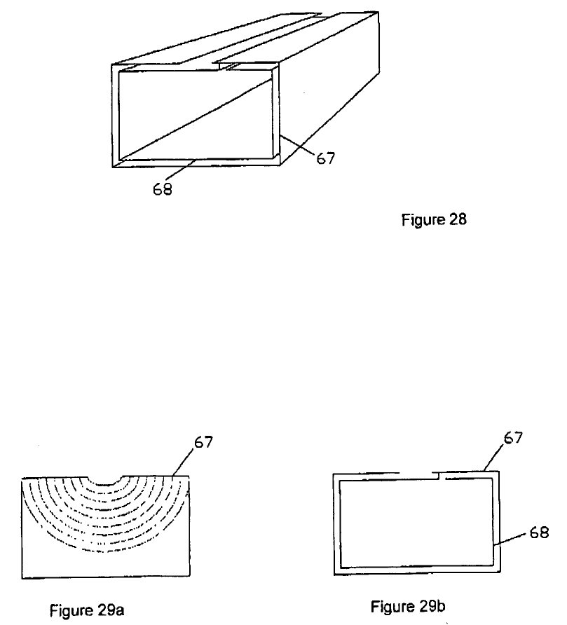

As shown in FIG. 28 the electric field shield design has an almost continuous conductive sheet 68 placed on the inside of the coil assembly, attached to the coil 67 near the ‘gap’ in which the capacitors are placed, crossing underneath the gap and proceeding all the way around the inside of the coil until almost reaching the starting point. This design, similarly needs to be left unconnected so that the magnetic field is not cancelled by opposing currents induced in this shield. Hence the electric field generated by the coil system is confined away from the item being scanned. In FIGS. 29a and 29b end views of the coil are shown.

In FIG. 29a the shape of the electric field in a standard rectangular single turn or slot coil is shown, where the curved lines represent the points of equal field strength within the coil. The majority of the electric field strength is confined within the gap of these coils. Although weaker in strength, some field will migrate into the area where an item of interest is being scanned. By comparing FIGS. 29a and 29b it can be seen that by placing the electrostatic shield 68 just under the gap will result in the deflection of the electric field away from the item being scanned.

It should be appreciated that the scope of the present invention is not limited to the specific embodiments described herein, and that variations and alternatives to the same may be provided that still fall within the scope of the invention in accordance with the spirit thereof.

1-21. (canceled)

22. A transmit and receive antenna assembly for detecting phenomenal signals using nuclear and electronic resonance detection technology, the assembly comprising a plurality of coils connected in parallel, each circumscribing a target volume for irradiating and receiving electromagnetic energy therein to detect the phenomenal signals.

23. An antenna as claimed in claim 22, wherein each coil comprises a loop segment and each loop segment is formed of pipe carrying a cooling fluid to cool the coil to achieve a lower noise floor.

24. An antenna as claimed in any one of claim 22, wherein each coil comprises a loop segment and said loop segments have width and spacing arranged so as to increase field homogeneity across the coil assembly.

25. An antenna as claimed in any of claim 22, wherein each coil comprises a loop segment and the loop segments are shaped to increase the Q of the total coil system by using a larger surface area than merely a single sheet coil.

26. An antenna as claimed in any one of claim 22, wherein each coil comprises a loop segment and the loop segments are disposed so as to produce a magnetic field that lies in an off-axis direction.

27. An antenna as claimed in claim 22, wherein the resonance of the antenna is broadened by tuning individual segments of the coil to different transmit frequencies.

28. An antenna as claimed in claim 22, including a switch or mechanical means to add in extra loop segments so as to increase the length of the antenna to accommodate extra large specimens for detecting therein.

29. An antenna as claimed in claim 22, wherein extra loop segments are used to inductively tune the antenna by moving said loop segments axially along the coil assembly.

30. An outer electromagnetic shield for housing a transmit and receive antenna assembly for detecting phenomenal signals using nuclear and electronic resonance detection technology, the shield having a central screen portion, a pair of waveguides disposed at opposing ends thereof, and a pair of sloping channel portions interconnecting the waveguides and screen portion;
wherein said screen portion, waveguides and channel portions are shaped to confine the magnetic field emanating from the transmit-receive coil therein;
and wherein the waveguides taper marginally inwardly from the inner end thereof to the outer end thereof, and the sloping channel portions comparatively slope more steeply inwardly from the opposing ends of the central screen portion to the inner ends of the waveguides, whereby the cross-sectional area of the inner ends of the waveguides is substantially smaller than the cross-sectional area of the opposing ends of the screen portion, and in turn the cross-sectional area of the outer ends of the waveguides is smaller than the cross-sectional area of the inner ends thereof.

31. An electric field shield for shielding specimens disposed within a transmit and receive antenna assembly for detecting phenomenal signals using nuclear and electronic resonance detection technology from the electric field of the antenna, comprising an inner conductive sleeve to be disposed in close proximity to the antenna within the target volume circumscribed thereby and in electrical isolation there from.

32. An electric field shield as claimed in claim 31, wherein the electric field shield is disposed around the inside of the coil to reduce the spatial dimensions of the electric field of the coil and direct the electric field away from the item being scanned.

33. An electric field shield as claimed in claim 31, wherein the conductive sleeve comprises a plurality of conductive strips extending axially of the antenna when disposed therein, said conductive strips being transversely spaced apart.

34. An antenna as claimed in claim 31, comprising:
a transmit and receive antenna;
an outer electromagnetic shield housing the transmit and receive antenna; and
an electric field shield for shielding specimens disposed within said transmit and receive antenna assembly.
